(19) United States
(12) Patent Application Publication
(10) Pub. No.: US 2018/0316555 A1
(43) Pub. Date: Nov. 1, 2018

(54) COGNITIVE PROFILING AND SHARING OF SENSOR DATA ACROSS IOT NETWORKS

(71) Applicant: Cisco Technology, Inc., San Jose, CA (US)

(72) Inventors: Gonzalo Salgueiro, Raleigh, NC (US); Michael David Hanes, Lewisville, NC (US); Joseph Michael Clarke, Raleigh, NC (US); Charles Calvin Byers, Wheaton, IL (US)

(21) Appl. No.: 15/582,642

(22) Filed: Apr. 29, 2017

(51) Int. Cl. H04L 12/24; H04L 29/08; G06N 99/00; G06N 5/04

(52) U.S. Cl. CPC H04L 41/0813; H04L 67/303; H04L 67/12; G06N 5/04; H04L 67/10; H04L 41/12; G06N 99/005; H04L 41/16

(57) ABSTRACT

In one embodiment, a supervisory device in a network maintains a plurality of node profiles for nodes in the network. The supervisory device receives, from a fog computing device in the network, node data associated with a particular node in the network. The supervisory device determines a node profile for the particular node based on the received node data and the maintained plurality of node profiles. The supervisory device causes installation of a fog computing application to the fog computing device based on the determined node profile for the particular node. The fog computing application is configured to process the node data associated with the particular node.

### TECHNICAL FIELD

The present disclosure relates generally to computer networks, and, more particularly, to cognitive profiling and sharing of sensor data across Internet of Things (IoT) networks.

### BACKGROUND

An emerging area of interest in the field of computer networking is the “Internet of Things” (IoT), which may be used by those in the art to refer to uniquely identifiable objects/things and their virtual representations in a network-based architecture. In particular, the next frontier in the evolution of the Internet is the ability to connect more than just computers and communications devices, but rather the ability to connect “objects” in general, such as lights, appliances, vehicles, window shades and blinds, doors, locks, etc.

A defining characteristic of many IoT nodes is their constrained nature in terms of computational resources. Notably, IoT nodes typically differ from traditional computing devices in that they often have very limited processing power, memory, computational speed and bandwidth, and power (e.g., a battery-powered sensor). In some cases, computations associated with IoT nodes may be offloaded to remote data centers and/or cloud-based services. For example, a sensor reading may be sent to a remote monitoring service for analysis via the Internet. However, doing so also increases the overall overhead of the network, as it requires communications back and forth between the analysis server/service and the endpoint node. Thus, recent efforts have been made to move these computations away from the cloud and into the “fog,” e.g., into the nodes/devices in or at the edge of the local network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrate an example communication network;

FIG. 2 illustrates an example network device/node;

FIGS. 3A-3C illustrate examples of node profiling;

FIGS. 4A-4D illustrate examples of using a node profile to automatically install a fog computing application to a fog computing device;

FIG. 5 illustrates an example of repeatedly profiling a node after fog computing application installation;

FIG. 6 illustrates an example simplified procedure to install a fog computing application to a fog computing device; and

FIG. 7 illustrates an example simplified procedure for providing node data to a supervisory device.

### DESCRIPTION OF EXAMPLE EMBODIMENTS

### Overview

According to one or more embodiments of the disclosure, a supervisory device in a network maintains a plurality of node profiles for nodes in the network. The supervisory device receives, from a fog computing device in the network, node data associated with a particular node in the network. The supervisory device determines a node profile for the particular node based on the received node data and the maintained plurality of node profiles. The supervisory device causes installation of a fog computing application to the fog computing device based on the determined node profile for the particular node. The fog computing application is configured to process the node data associated with the particular node.

In further embodiments, a device in a network detects a new node in the network. The device obtains node data associated with the new node. The device sends the node data to a supervisory device. The supervisory device maintains a plurality of node profiles for nodes in the network. The device receives an application to process the node data selected based on a node profile for the particular node identified by the supervisory device from the sent node data.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes can be arranged in a hierarchy of levels, where lower level fog nodes are closer to the IoT things, and higher level fog nodes are closer to the cloud. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

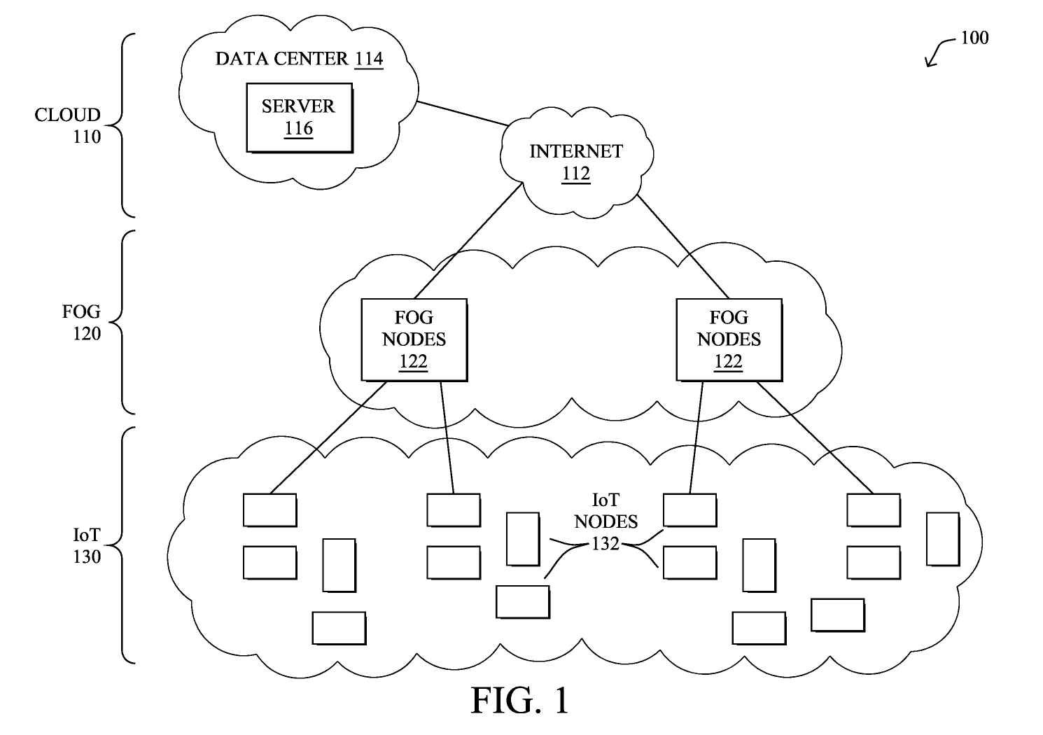

FIG. 1 is a schematic block diagram of an example simplified computer network 100 illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely the cloud 110, fog 120, and IoT device 130. Illustratively, the cloud 110 may comprise general connectivity via the Internet 112, and may contain one or more datacenters 114 with one or more centralized servers 116 or other devices, as will be appreciated by those skilled in the art. Within the fog layer 120, various fog nodes/devices 122 may execute various fog computing resources on network edge devices, as opposed to datacenter/cloud-based servers or on the endpoint nodes 132 themselves of the IoT layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

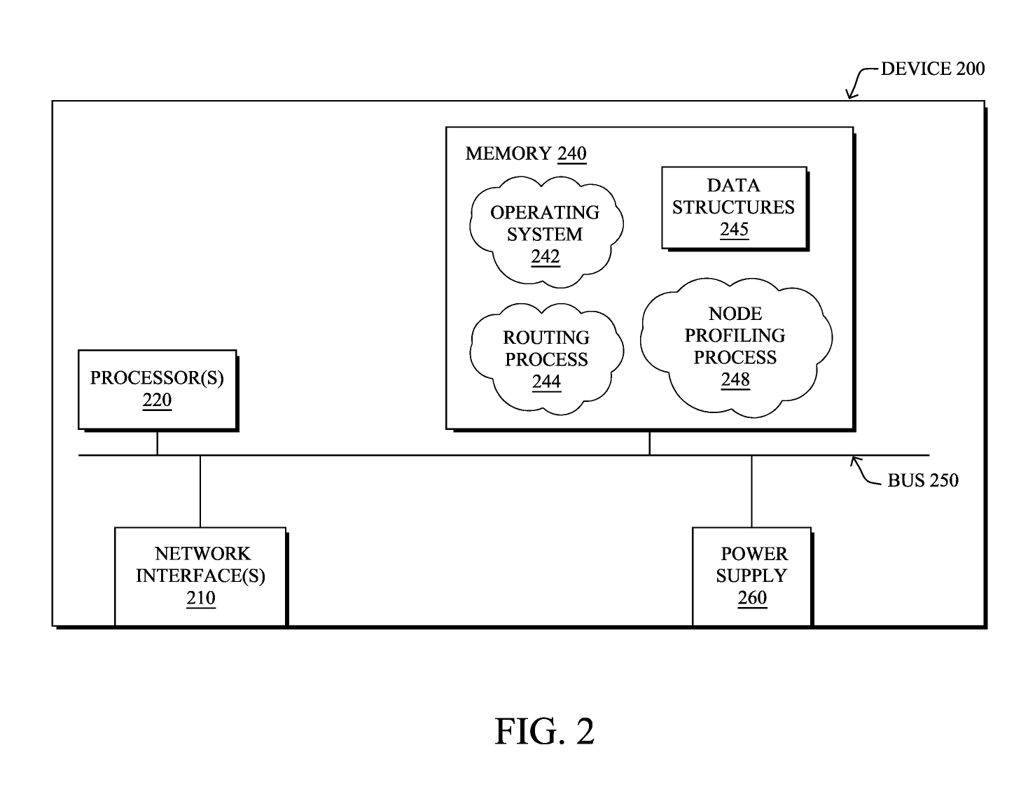

FIG. 2 is a schematic block diagram of an example computing device/node 200 that may be used with one or more embodiments described herein e.g., as any of the devices shown in FIG. 1 above or any of the devices described further below. The device may comprise one or more network interfaces 210 (e.g., wired, wireless, cellular, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network 100. The network interfaces may be configured to transmit and/or receive data using a variety of different communication protocols. Note, further, that the nodes may have two or more different types of network connections 210, e.g., wireless and wired/physical connections, and that the view herein is merely for illustration. Also, while the network interface 210 is shown separately from power supply 260, for devices using PLC, the network interface 210 may communicate through the power supply 260, or may be an integral component of the power supply. In some specific configurations the PLC or Power over Ethernet (PoE) signal may be coupled to the power line feeding into the power supply.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an illustrative node profiling process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process/services 244 include computer executable instructions executed by processor 220 to perform functions provided by one or more routing protocols, such as an Interior Gateway Protocol (IGP) (e.g., Open Shortest Path First, “OSPF,” and Intermediate-System-to-Intermediate-System, “IS-IS”), the Border Gateway Protocol (BGP), etc., as will be understood by those skilled in the art. These functions may be configured to manage a forwarding information database including, e.g., data used to make forwarding decisions. In particular, changes in the network topology may be communicated among nodes/devices 200 using routing protocols, such as the conventional OSPF and IS-IS link-state protocols (e.g., to “converge” to an identical view of the network topology).

Notably, routing process 244 may also perform functions related to virtual routing protocols, such as maintaining VRF instance, or tunneling protocols, such as for MPLS, generalized MPLS (GMPLS), etc., each as will be understood by those skilled in the art. Also, EVPN, e.g., as described in the IETF Internet Draft entitled “BGP MPLS Based Ethernet VPN” <draft-ietf-12vpn-evpn>, introduce a solution for multipoint L2VPN services, with advanced multi-homing capabilities, using BGP for distributing customer/client media access control (MAC) address reach-ability information over the core MPLS/IP network.

Another example protocol that routing process 244 may implement, particularly in the case of LLN mesh networks, is the Routing Protocol for Low Power and Lossy (RPL), which provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

As described in greater detail below, node profiling process 248 generally includes computer executable instructions that, when executed by processor(s) 220, cause device 200 to operate as part of a fog-based, node profiling and fog application distribution infrastructure within the network. According to various embodiments, node profiling process 248 may employ any number of machine learning techniques, to assess and profile data associated with various endpoint nodes/devices the network. In general, machine learning is concerned with the design and the development of techniques that receive empirical data as input (e.g., data associated with a given node/device in the network) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, experience prediction process 248 can use the model M to classify new data points, such as data associated with a sensor or actuator distributed in the network. Often, M is a statistical model, and the cost function is inversely proportional to the likelihood of M, given the input data.

In various embodiments, node profiling process 248may employ one or more supervised, unsupervised, or semi-supervised machine learning models to analyze data associated with a sensor or actuator node/device in the network, to determine its profile. Generally, supervised learning entails the use of a training dataset, which is used to train the model to apply labels to the input data. For example, the training data may include sample network data that may be labeled as associated with a given node/device type. On the other end of the spectrum are unsupervised techniques that do not require a training set of labels. Notably, while a supervised learning model may look for previously seen network data that has been labeled accordingly, an unsupervised model may instead look to cluster or otherwise group nodes that exhibit similar characteristics/data. Semi-supervised learning models take a middle ground approach that uses a greatly reduced set of labeled training data.

Example machine learning techniques that node profiling process 248 can employ may include, but are not limited to, nearest neighbor techniques (e.g., k-nearest neighbor models, replicator nearest neighbor models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

As noted above, current IoT architectures typically operate hierarchically as follows: Cloud→Fog(s)→IoT Gateway→IoT nodes (e.g., sensors and/or actuators). However, configuring the IoT gateways and hierarchy of fog nodes to recognize and classify node data associated with the nodes is very error prone and requires a large amount of operational resources. Further, determining which fog computing application(s) are to be installed to the fog computing nodes/devices, how the IoT nodes should be configured, etc., all add additional complexity to implementing and maintaining the network.

Cognitive Profiling and Sharing of Sensor Data Across IoT Networks

The techniques herein build node profiles for various types of IoT nodes (e.g., sensors, actuators, etc.) which can be used to identify and download appropriate fog computing applications to the corresponding fog computing devices. In some aspects, machine learning can be used to formulate and update the node profiles. In further aspects, the node profiles may be stored and maintained in a centralized or distributed database of a supervisor for sharing with other IoT gateways/fog computing devices across the network. Machine learning can also be applied after the profile and fog computing application have been applied, to provide real-time configuration changes to IoT nodes, along with predictive maintenance to warn of impending sensor failures or calibration problems.

Specifically, according to one or more embodiments of the disclosure as described in detail below, a supervisory device in a network maintains a plurality of node profiles for nodes in the network. The supervisory device receives, from a fog computing device in the network, node data associated with a particular node in the network. The supervisory device determines a node profile for the particular node based on the received node data and the maintained plurality of node profiles. The supervisory device causes installation of a fog computing application to the fog computing device based on the determined node profile for the particular node. The fog computing application is configured to process the node data associated with the particular node.

Illustratively, the techniques described herein may be performed by hardware, software, and/or firmware, such as in accordance with the node profiling process 248, which may include computer executable instructions executed by the processor 220 (or independent processor of interfaces 210) to perform functions relating to the techniques described herein, e.g., in conjunction with routing process 244.

Operationally, the techniques herein introduce a fog and cloud-based system that automates, scales, self-learns, and shares sensor profiles across an IoT network or even multiple local IoT networks in a service provider or Fog as a Service (FaaS) environment. Furthermore, once these profiles are in place for a sensor, additional capabilities related to ideal sensor configuration and predictive maintenance are also possible using the techniques herein.

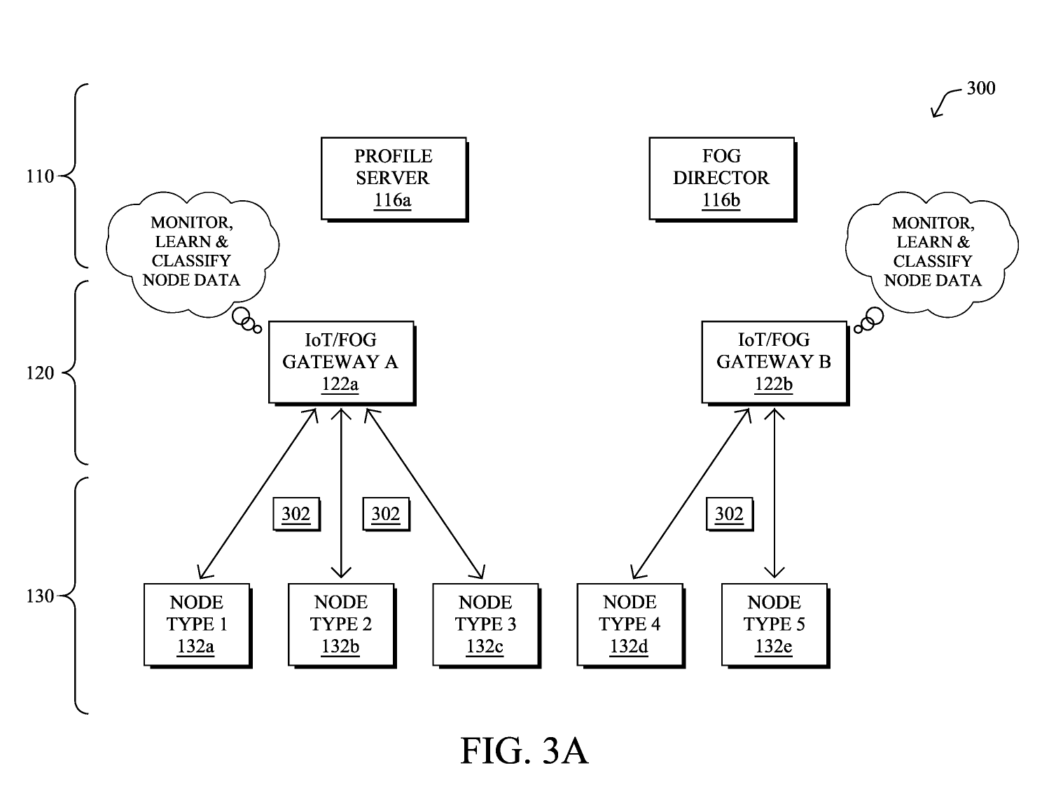

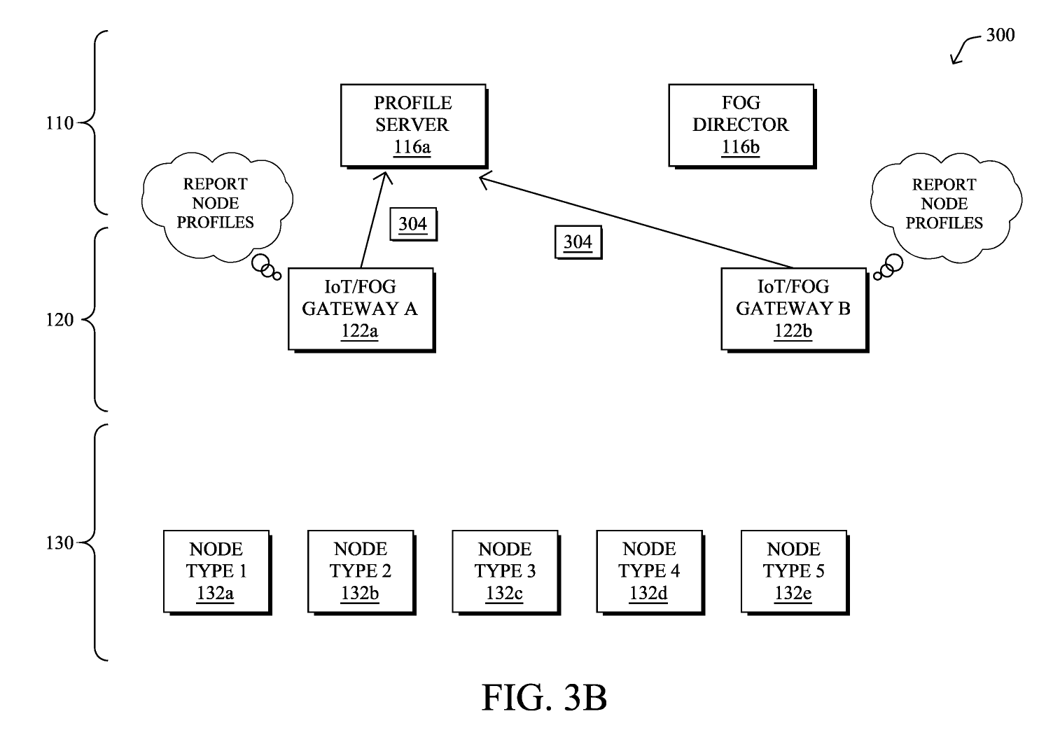

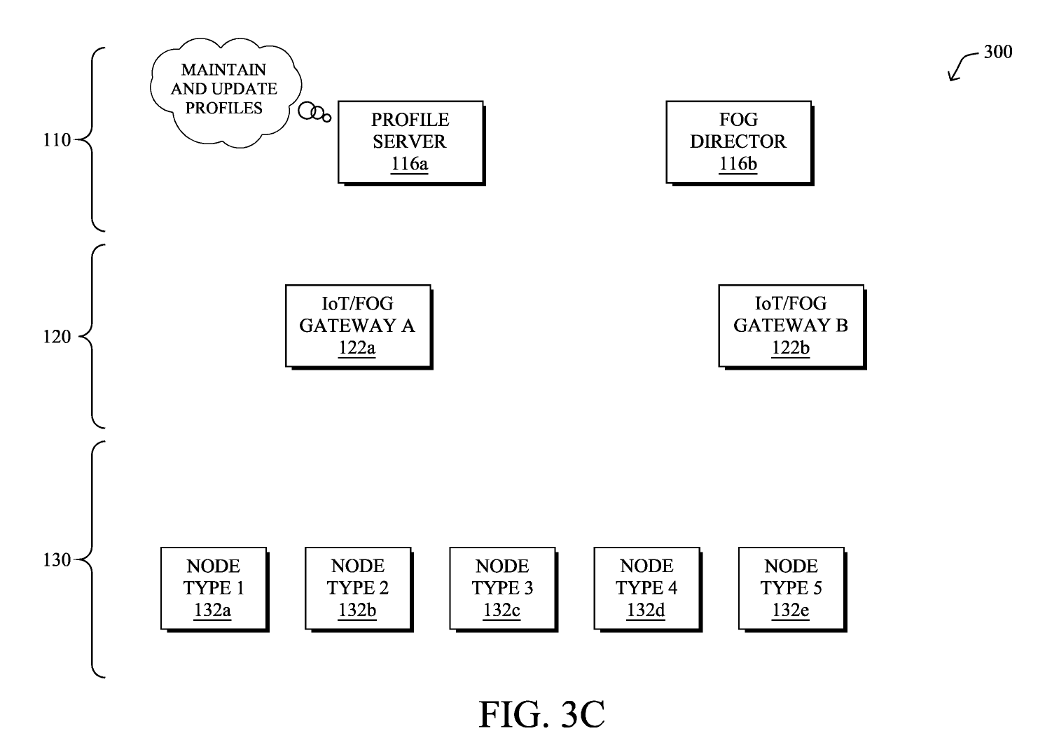

FIGS. 3A-3C illustrate examples of node profiling, according to various embodiments. As shown in FIG. 3A, consider the case of a network 300 that includes a first local IoT network serviced at the fog layer 120 by IoT/fog gateway A (e.g., a fog computing device 122a) and a second local IoT network serviced at fog layer 120 by IoT/fog gateway B (e.g., a fog computing device 122b). Accordingly, each local IoT network may also include any number of IoT nodes 132 at the IoT node/device layer 130. For example, IoT/fog gateway A may service, and communicate with, IoT nodes 132a-132c. Similarly, IoT/fog gateway B may service, and communicate with, IoT nodes 132d-132e.

IoT nodes 132a-132e may be of any number of different types. For example, node 132a may be a specific type of sensor (e.g., a temperature sensor, a camera, etc.), whereas node 132b may be a specific type of actuator (e.g., a light fixture, fan, etc.). Node types may also be related to the specific manufacturer of a given node, a hardware version of a given node, a firmware version of a given node, or any other information that can be used to categorize a given IoT node.

Network 300 may further include any number of supervisory devices 116 at cloud layer 110. For example, as shown, network 300 may include a profiler server 116a and a fog director 116b. In various embodiments, and as described in greater detail below, profiler server 116a may act as a central repository for node profiles across the local IoT networks serviced by IoT/fog gateways A and B. In further embodiments, fog director 116b may be operable to provide control over IoT/fog gateways A and B such as, for example, by controlling their configurations, installed fog computing applications, etc. As would be appreciated, profiler server 116a and/or fog director 116b may be implemented on a single, physical computing element or across multiple computing elements, as is typical in cloud-computing environment. In such cases, the term “supervisory device” refers to the collection of the one or more physical computing elements that perform the functions described with respect to profiler server 116a and/or fog director 116b.

As shown in FIG. 3A, the techniques herein generally involve a fog gateway or hierarchical fog node (e.g., a fog computing device 122) monitoring and learning from the node data 302 (e.g., node traffic) that passes through it. In turn, the fog computing device 122 may build a profile based on the link traffic associated with the nodes 132 that it observes. For example, IoT/fog gateway A may monitor the node data present in the link traffic associated with node 132a. Numerous characteristics of this observed link/traffic data may be considered, including data priority/quality of service (QoS), variation of payload data (e.g., presence of payload, size, and encoding), frequency of transmission, bandwidth consumed, traffic statistics, security encoding, calibration status, responses/acknowledgements, and so on. Any information passing through the gateway that would enable the identification of the types and individual instances of sensors or actuators (e.g., serial numbers, geographic locations, crypto keys, etc.) may also be considered by the fog computing device.

In various embodiments, the fog computing device may leverage machine learning to learn the characteristics of all IoT nodes connected to it. In particular, various machine learning mechanisms can be deployed as part of classifying this node data. At a high level, a supervised learning approach would involve taking known sensor data and classifying it in various buckets to create a set of known profiles (e.g., using logistic regression, a neural network, or the like). Node manufacturers could also provide the input profile data as a starting point, in order to construct the training set for the machine learning-based profiling process. The training sets could then be augmented based on the observed characteristics described above (e.g., payload fingering, bandwidth, encoding, etc.) in actual use within the network. The machine learning mechanism could be trained on this set with the classification output being the desired outcome to take (e.g., processing to perform on the data, application group to install to the fog computing device, etc.).

Additionally, unsupervised learning could be used to perform clustering of similar node data flows. In the clustering approach, one could choose a specific number of clusters based on attributes such as application groups or types of service. Once the number of clusters is determined, the traffic flows can be grouped into those clusters. In turn, after identifying the cluster sets, choices can be made as to which class of service or which applications must be deployed to service the clusters. A combination of supervised and unsupervised learning techniques could be utilized, in further embodiments. Often, the output of the machine learning analysis will be an identification of the type of node and its corresponding attributes. However, sometimes the machine learning mechanism may be less certain, and produce a probability that it is a node of a certain type, or that it is a new, unknown type.

In some embodiments, the profiling of the node data may be performed instead, or in part, by profiler server 116a. For example, IoT/fog gateways A and B may instead send traffic data log reports to profiler server 116a for profile assessment. However, this approach would also significantly increase the WAN bandwidth usages, as it would require additional traffic to and/or from the cloud.

In FIG. 3B, IoT/fog gateways A and B may each report their obtained node data 304 regarding their respective nodes 132 to profiler server 116a. Such node data 304 may include, for example, captured traffic data and statistics associated with nodes 132 and/or, as shown, the node profiles locally determined by the fog computing devices.

In turn, as shown in FIG. 3C, profiler server 116a may check the constructed node profile against existing profiles maintained by profiler server 116a, to see whether a similar profile already exists. If so, that profile may be automatically downloaded as a starting point for all gateways and fog nodes that will be involved in processing readings from the node. If this profile is new, it is then stored by profiler server 116a in the cloud layer 110, and can be accessed by other similar nodes, to help simplify and speed up their configuration process. New profiles can be created manually, or use semi-automatic or automatic machine learning techniques.

A key aspect of the profiling infrastructure is the profiler server 116a itself. During operation, profiler server 116a may manage and continuously update all of the node profiles, network-wide. New profiles can be added when detected, and existing profiles updated, as needed. Often in IoT networks, the operating environment for sensors and actuators is continuously changing. In some embodiments, machine learning executed by profiler server 116a could also detect that a profile requires slightly different parameters in response to these changes, and integrate them into its profile database. Profiler server 116a could also update the learning machines used to classify the node data (either executed locally by server 116a or in the fog layer 120), as it learns more from the profiles it receives. Doing so makes the fog gateways ‘smarter’ and more responsive in highly dynamic IoT networks. In another embodiment, profiler server 116a can even cause fog applications to be preloaded onto a given fog computing device, based on expected types of nodes with which the fog computing device is, or is predicted to be, connected.

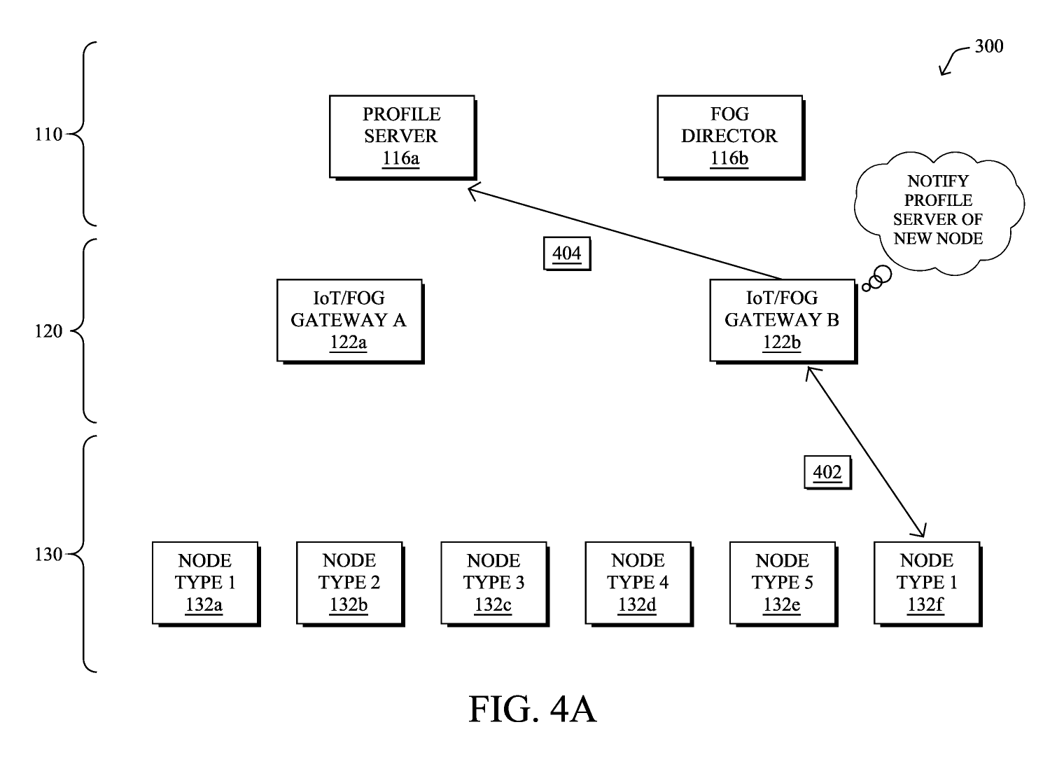

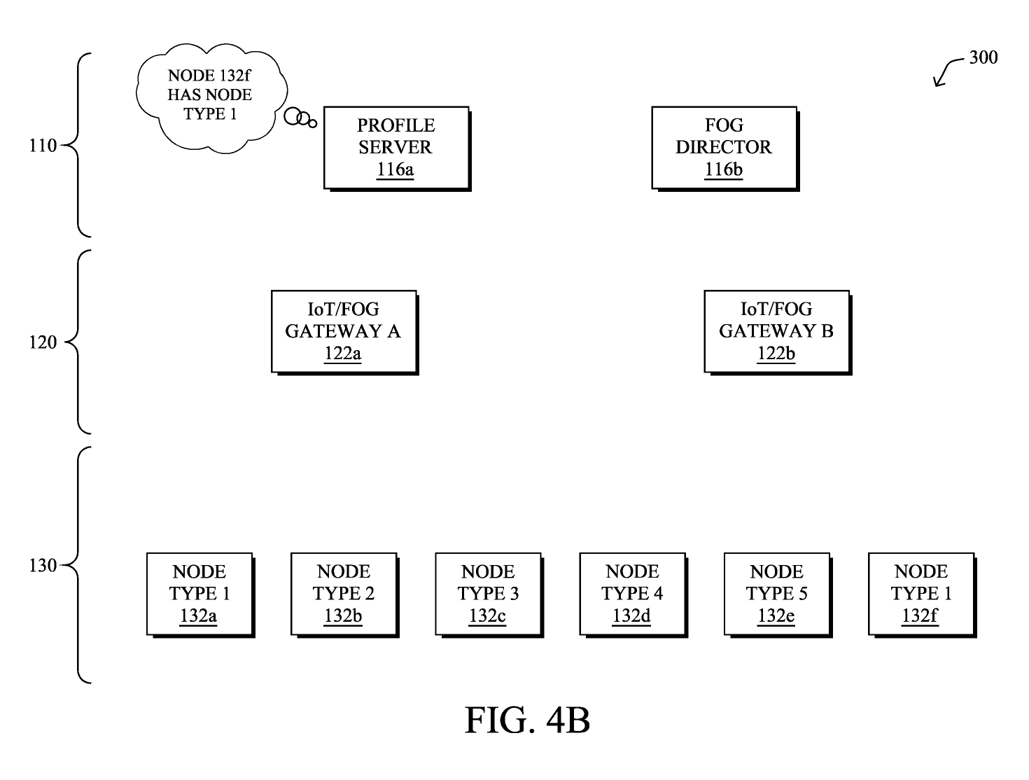

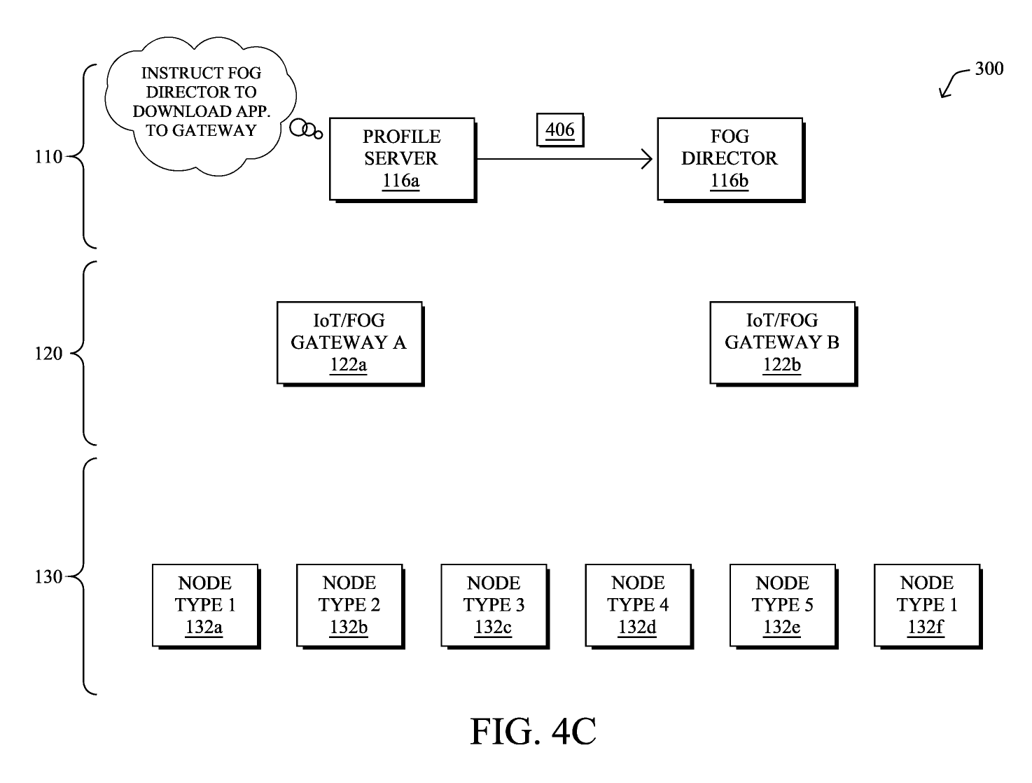

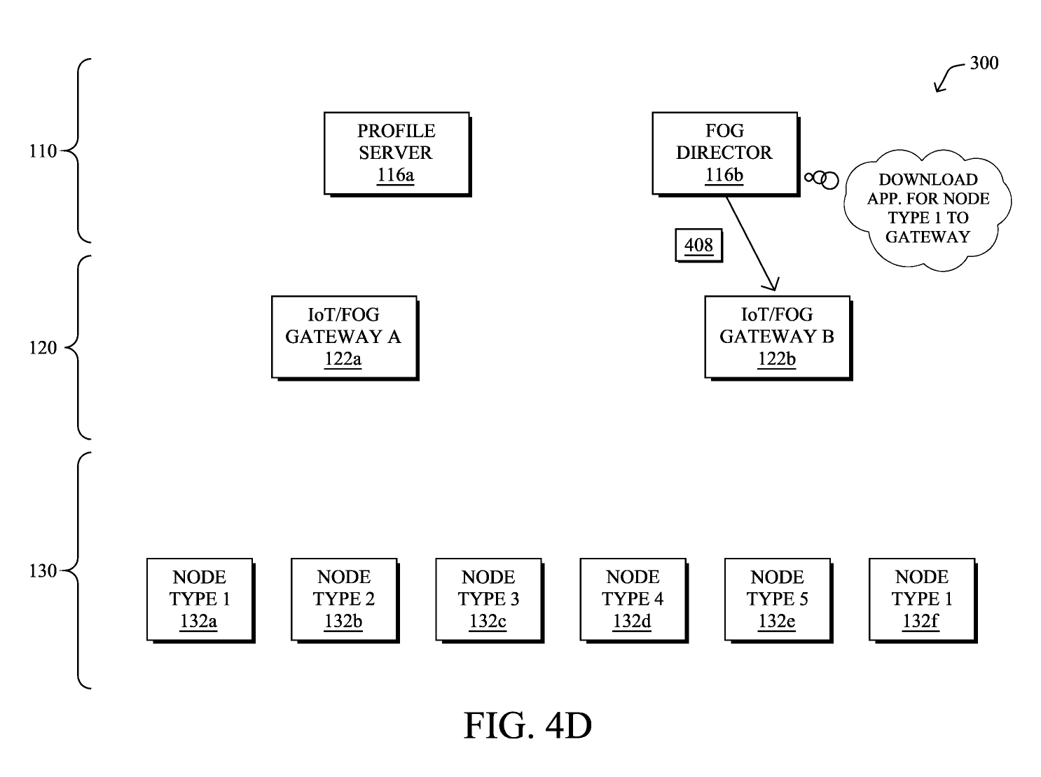

FIGS. 4A-4D illustrate examples of using a node profile to automatically install a fog computing application to a fog computing device, according to various embodiments. As shown in FIG. 4A, assume that a new node 132f comes online and joins the local IoT network of IoT/fog gateway B. Further, assume that node 132f is of the same node type as node 132a in the local IoT network of IoT/fog gateway A, which has already been profiled. In such a case, when node 132f comes online, IoT/fog gateway B may obtain node data regarding node 132f (e.g., by observing its traffic 402, sensor data, etc.). In turn, the fog computing device may determine the node profile for node 132f and check the profile against profiler server 116a. For example, it may send a message 404 to profiler server 116a that includes the node data for node 132f, which may comprise the node profile determined by the fog computing device.

In FIG. 4B, profiler server 116a may check the profile of node 132f against those in its profile database, to see whether other nodes in network 300 share the same node type of node 132f. For example, if nodes 132a and 132f exhibit the same or similar profiles, profiler server 116a may determine that both nodes are of node type ‘1. ’

Using this information, the profiler server may identify an associated fog computing application for the node type and cause the application to be downloaded to the appropriate fog computing device(s). For example, as shown in FIG. 4C, profiler server 116a may send an instruction 406 to fog director 116b to download the fog computing application associated with node type ‘1’ to IoT/fog gateway B. In turn, as shown in FIG. 4D, fog director 116b may download application 408 to the appropriate fog computing device(s) that are exposed to the traffic of node 132f. Such an application may be configured, e.g., to process the data associated with nodes of node type ‘1.’ For example, if node 132f is a sensor of a certain type, its corresponding fog computing application may process sensor readings from this sensor.

Alternatively, based on what the profile indicates about the traffic flow of node 132f , and without deeper knowledge about the data meaning within the flow, the gateway may be instructed to drop the packets to alleviate bandwidth constraints, or perform other QoS enforcement actions. This determination may come from the machine learning application of the profile parameters. In this case, the packets associated with node 132f could be predicted to be in an unimportant class, and thus dropped. In other cases, the traffic may be classified as highly critical, and its priority on processors and network resources could be adjusted, accordingly.

The IoT gateway and other intelligent fog computing devices that aggregate and connect to the IoT nodes 132 have the ability to learn from the sensor/node data that they receive. This learning can take place upon installation, or as new IoT nodes 132 are added to network 300. Cognitive applications in fog layer 120 can classify and determine the node type and potentially other information as well, such as where the data needs to be sent, with what priority, etc. This node profile can also be shared and updated through an IoT network in scalable manner, which requires cooperation between the fog director 116b, sensor profile server, the distributed IoT application running on the hierarchy of fog nodes and IoT gateways.

An additional embodiment is one where node vendors or manufactures could provide their own profiles or signatures in a manner that could expedite the matching of their data profile and patterns so it can uniquely identify the node type, manufacturer, etc. Given that information, customized fog applications can be intelligently assigned on a per-deployment basis such that it is optimized for that particular data handling, application, or environment. For example, for a particular deployment, a one degree, or fraction of a degree, temperature difference may be critical. For other deployments, however, that level of temperature granularity may not be significant at all. In yet another embodiment, the node profile information can be used to apply proactive trigger or service level agreement (SLA)-based policy enforcement on a profile basis.

The above techniques can be used particularly to profile IoT sensors, and their data transport in the IoT node→gateway/fog→cloud direction. In addition, the same profiling process could also be applied in the cloud→fog/gateway→IoT node, in the case of IoT actuators. The machine learning-based profiling could also allow the profiles and machine learning models acting in each direction to interact, producing a more cohesive view of the entire IoT network and the requirements of all of its nodes/devices.

One important aspect of the techniques herein is the ability to work in the fog. Fog nodes may be fairly isolated in their views of the needs of sensors and actuators of potentially millions of different types. By using this notion of profiles that can be dynamically discovered, and then tuned using machine learning techniques by referencing a centralized profiler server, gateways and fog nodes should be much easier to configure (e.g., both their networking parameters and software configurations). Their performance will converge to an optimal level much faster, and track dynamic IoT network conditions much more responsively than it could if the only view of the network requirements of a sensor was from the perspective of a single fog computing device. Further, these techniques can greatly assist in the automation and operations of complex sensor-fog networks, reducing the required operational resources, security threats, and configuration mistakes often found in IoT networks.

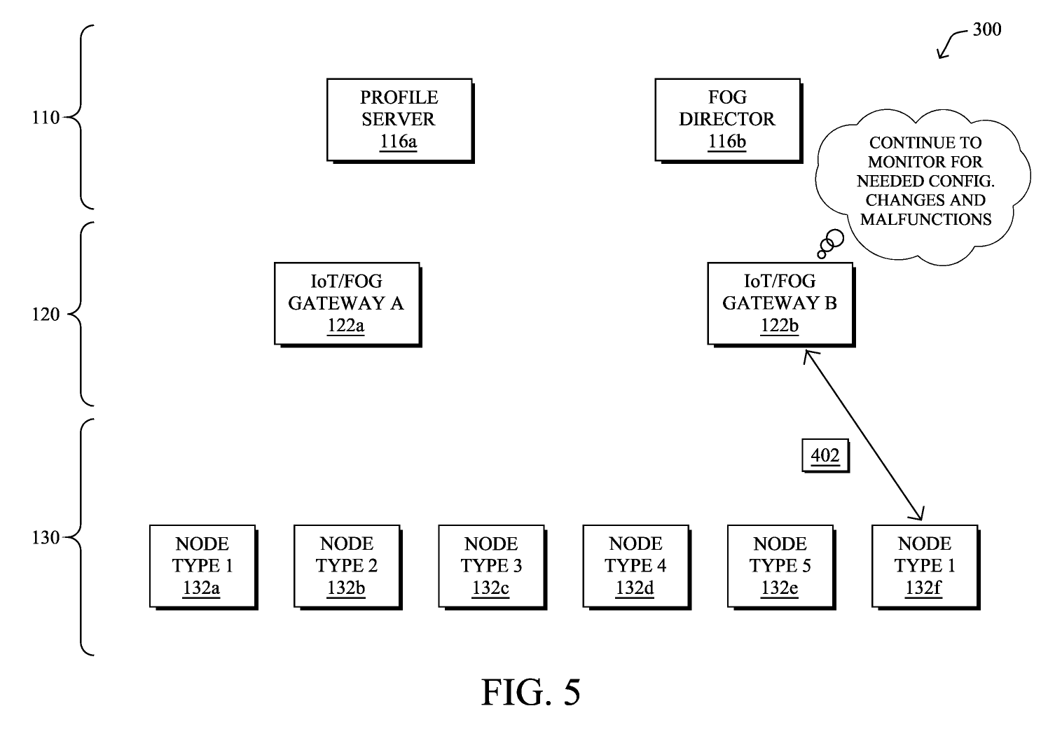

Once the node profile has been determined and the correct fog computing application has been downloaded to the gateway and made operational, the fog computing application may perform its configured actions on the sensor or actuator data. In further embodiments, the fog computing device may also continue to monitor and classify this node data using a combination of traditional (e.g., rule-based, etc.) and machine learning techniques. Notably, continuing to monitor the node data, even after installation of its corresponding fog computing application, allows for the additional capabilities highlighted below. For example, as shown in FIG. 5, even after installation of the fog computing application for node 132f, IoT/fog gateway B may continue to monitor the operations of node 132f, to check for potential node configuration changes, evolving security threats, network load concerns, or malfunctions.

The first of the post-installation capabilities is real-time sensor/device configuration, in one embodiment. For example, assume that the IoT node is a video camera that is streaming data. Video cameras have multiple settings for frame rate, file type, resolution, etc. However, determining the ideal settings for this node based on the conditions of the network is particularly challenging. In some cases, a high resolution or frame rate is required, while in others it is not. If network jitter and/or packet loss is high, the video camera should be set for a lower resolution or frame rate or maybe a video encoding that offers better resiliency to these impairments. By continuing to monitoring the node, the fog application associated with the node profile can be used to automatically make configuration adjustments in approximately real-time.

Another post-installation capability provided by the techniques herein is the ongoing predictive maintenance of the connected sensors and smart objects. In particular, the fog computing device's machine learning may perform constant or periodic analysis of the streaming node data look for anomalies and fingerprints within the data that indicate a lack of calibration or other malfunction. For example, over time, sensors will become uncalibrated, especially ones that are taking sensitive measurements or ones that are located in harsh environments. A repeated analysis of the sensor data by the fog computing device will allow for trends to be discovered and this determination to be made and flagged at the fog level. This would lead to the sensor data being marked as unreliable for upstream applications and processing. Maintenance could then be performed on the sensor to recalibrate it or replace it.

Another example of predictive maintenance is the fact that it is not uncommon for electrical devices, like smart objects, to act faulty or erratic before a hard failure. Often, the pattern of misbehavior is consistent with previously observed failures, and can be seen in the sensor data being transmitted. A common example of this is seen as the battery in a sensor is close to failure. A machine learning analysis of the sensor data can be used to learn the “fingerprints” of an upcoming sensor failure and then provide a proactive notification for sensor replacement. Discovering changing radio interference or propagation characteristics on wireless networks is another example of a predictive maintenance capability of this system. For some use cases, like manufacturing, transportation, healthcare, and utilities, predictive maintenance of sensors is critical.

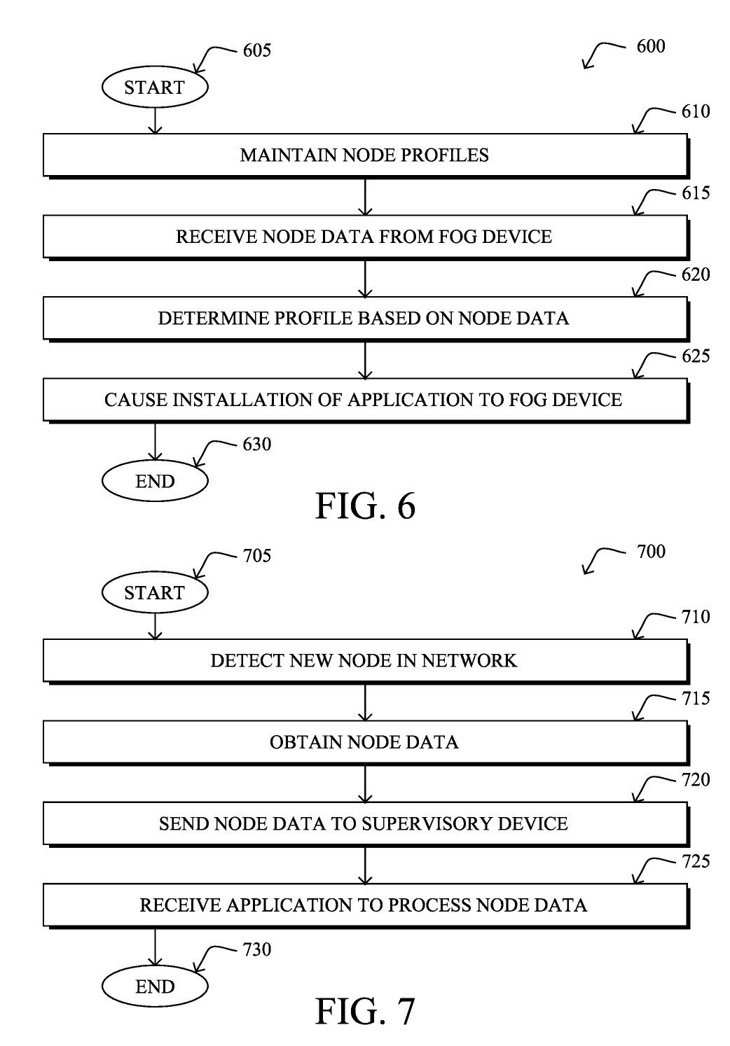

FIG. 6 illustrates an example simplified procedure for using a node profile to install a fog computing application to a fog device, in accordance with one or more embodiments described herein. For example, a non-generic, specifically configured device (e.g., device 200) in a network may perform procedure 600 by executing stored instructions (e.g., process 248). For example, a supervisory device in a network, such as a profiling server overseeing any number of local IoT networks, may perform procedure 600. The procedure 600 may start at step 605, and continues to step 610, where, as described in greater detail above, the supervisory device may maintain a plurality of node profiles for nodes in the network. Such profiles may be based on node data regarding the nodes and, in many cases, observed traffic associated with the nodes. For example, sensor reading traffic from a given sensor node may be used to form the profile for the node. Associated with these node profiles may be different node types.

In some embodiments, the profiles may also be determined using machine learning. For example, a supervised approach may use a training set of node data that is labeled with different node types, to train a profiling model. In another example, an unsupervised approach may use a machine learning-based clustering approach to group nodes having similar node data. Such profiling may be performed by one or more fog computing devices in the network and/or by the supervisory device itself.

At step 615, as detailed above, the supervisory device may receive node data associated with a particular node in the network from a fog computing device in the network. Such node data may include, for example, data regarding traffic associated with the node, profile information generated by the fog computing device, or any other information that may be used by the supervisory device to discern the node type.

At step 620, the supervisory device may determine a node profile for the particular node based on the received node data associated with the particular node and on the plurality of node profiles maintained by the supervisory device, as described in greater detail above. For example, the supervisory device may use profile information for the particular node to identify one or more similar node profiles from the plurality of profiles. Such profiles may also be associated with different node types, thereby also identifying the type of the particular node from the matching between the profile for the particular node and the node type associated with the profile(s) of its closest match(es).

At step 625, as detailed above, the supervisory device may cause installation of a fog computing application to the fog computing device based on the determined node profile for the particular node. In some embodiments, the fog computing application is configured to process the node data associated with the particular node. The application may also be, in some cases, operable to make configuration changes to the particular node and/or perform predictive maintenance. For example, the fog computing device, after installation of the application may continue to monitor the particular node and, based on its current profile, predict when a failure is likely. Procedure 600 then ends at step 360.

FIG. 7 illustrates an example simplified procedure for providing node data to a supervisory device, in accordance with the embodiments herein. Procedure 700 may be performed by a non-generic, specifically configured device (e.g., device 200) in a network by executing stored instructions (e.g., process 248). For example, a fog computing device in a network, such as a router, switch, or gateway, may perform procedure 700. The procedure 700 may start at step 705, and continues to step 710, where, as described in greater detail above, the device may detect a new node in the network. For example, a new IoT sensor or actuator may join the local network of the device and begin communicating via the device.

At step 715, as detailed above, the device may obtain node data associated with the node. In some embodiments, the device may monitor traffic to and/or from the new node, to capture information about the node (e.g., the make, model, data types, etc.). In further embodiments, the node data may also include profile information derived by the device based on the observed traffic. For example, the device may use machine learning to generate a node profile for the node, based on its observations of the new node.

At step 720, the device may send the node data to a supervisory device, as described in greater detail above. In some cases, the supervisory device may be a profiling server that acts as a central node profile repository across one or more local networks. In turn, the supervisory device may use the node data, which may include profile information generated by the device, to identify nodes with similar profiles. Based on the deployed application for these similar nodes, the supervisory device may cause that application to be downloaded to the device. For example, the supervisory device may instruct a fog director overseeing the device to download the identified application.

At step 725, as detailed above, the device may receive the application to process the node data. As noted, the application may be a fog computing application that is selected based on a node profile for the particular node identified by the supervisory device from the sent node data. For example, in the case of the new node being a sensor, the application may assess sensor readings from the node on the device and raise alerts as necessary. Procedure 700 then ends at step 730.

It should be noted that while certain steps within procedures 600-700 may be optional as described above, the steps shown in FIGS. 6-7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 600-700 are described separately, certain steps from each procedure may be incorporated into each other procedure, and the procedures are not meant to be mutually exclusive.

The techniques described herein, therefore, provide the following:
Profile-based decisions that optimize fog node assignments;
Intelligent handling of sensor data by machine learning-enabled gateways/fogdevices;
Predictive capabilities for Fog-based applications can automatically configure software on each layer of a gateway/fog hierarchy;
Proactive policy enforcement framework for Fog applications;
Faster time to service for new sensors;
Better responsiveness to dynamic IoT network conditions;
Less manual effort needed to configure and tune sensor networking;
Ongoing, real-time configuration of sensors based on network conditions or other parameters; and
Machine learning analysis of sensor and/or actuator data to identify impending failures or calibration concerns (predictive maintenance).

While there have been shown and described illustrative embodiments that provide for profiling IoT nodes, it is to be understood that various other adaptations and modifications may be made within the spirit and scope of the embodiments herein. For example, while certain embodiments are described herein with respect to using certain models for purposes of profiling a node, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
maintaining, by a supervisory device in a network, a plurality of node profiles for nodes in the network;
receiving, at the supervisory device and from a fog computing device in the network, node data associated with a particular node in the network;
determining, by the supervisory device, a node profile for the particular node based on the received node data and the maintained plurality of node profiles; and
causing, by the supervisory device, installation of a fog computing application to the fog computing device based on the determined node profile for the particular node, wherein the fog computing application is configured to process the node data associated with the particular node.

2. The method as in claim 1, wherein causing installation of the fog computing application to the fog computing device comprises:
instructing, by the supervisory device, a fog computing director to install the fog computing application to the fog computing device.

3. The method as in claim 1, wherein the particular node comprises a sensor, and wherein the node data associated with the particular node comprises sensor data from the particular node.

4. The method as in claim 1, wherein maintaining the plurality of node profiles comprises:
using, by the supervisory device, machine learning to determine the node profiles based on node data obtained from the nodes in the network.

5. The method as in claim 1, wherein the node data associated with the particular node comprises node profile information generated by the fog computing device using machine learning and based on observed traffic associated with the particular node.

6. The method as in claim 1, wherein the fog computing device comprises a router, switch, or gateway.

7. The method as in claim 1, wherein the fog computing application is a predictive maintenance application for the particular node.

8. A method comprising:
detecting, by a device in a network, a new node in the network;
obtaining, by the device, node data associated with the new node;
sending, by the device, the node data to a supervisory device, wherein the supervisory device maintains a plurality of node profiles for nodes in the network; and
receiving, at the device, an application to process the node data selected based on a node profile for the particular node identified by the supervisory device from the sent node data.

9. The method as in claim 8, further comprising:
using, by the device, machine learning to generate node profile data for the new node, wherein the node data sent to the supervisory device comprises the generated node profile data.

10. The method as in claim 8, wherein the device is a fog computing device and comprises at least one of: a router, a switch, or a gateway.

11. The method as in claim 8, wherein the fog computing application is a predictive maintenance application for the particular node.

12. The method as in claim 8, wherein the new node comprises a sensor, and wherein the node data associated with the node comprises sensor data from the node.

13. The method as in claim 8, further comprising:
determining, by the device, a configuration change for the node based on the node data; and
providing, by the device, the configuration change to the node.

14. An apparatus, comprising:
one or more network interfaces to communicate with a network;
a processor coupled to the network interfaces and configured to execute one or more processes; and
a memory configured to store a process executable by the processor, the process when executed operable to:
maintain a plurality of node profiles for nodes in the network;
receive, from a fog computing device in the network, node data associated with a particular node in the network;
determine a node profile for the particular node based on the received node data and the maintained plurality of node profiles; and
cause installation of a fog computing application to the fog computing device based on the determined node profile for the particular node, wherein the fog computing application is configured to process the node data associated with the particular node.

15. The apparatus as in claim 14, wherein the apparatus causes installation of the fog computing application to the fog computing device by:
instructing a fog computing director to install the fog computing application to the fog computing device.

16. The apparatus as in claim 14, wherein the particular node comprises a sensor, and wherein the node data associated with the particular node comprises sensor data from the particular node.

17. The apparatus as in claim 14, wherein the apparatus maintains the plurality of node profiles by:
using machine learning to determine the node profiles based on node data obtained from the nodes in the network.

18. The apparatus as in claim 14, wherein the node data associated with the particular node comprises node profile information generated by the fog computing device using machine learning and based on observed traffic associated with the particular node.

19. The apparatus as in claim 14, wherein the fog computing device comprises a router, switch, or gateway.

20. The apparatus as in claim 14, wherein the fog computing application is a predictive maintenance application for the particular node.
